(19) United States
(12) Patent Application Publication
(10) Pub. No.: US 2004/0084138 A1
(43) Pub. Date: May 6, 2004

(54) Reactive adhesive with a low monomer content and with multistage hardening

(76) Inventors: Guenter Henke, Neuss (DE); Kamil Kalus, Duesseldorf (DE); Annabelle Guilleux, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/415,009

(22) PCT Filed: Oct. 13, 2001
(86) PCT No.: PCT/EP01/11856

(30) Foreign Application Priority Data
Oct. 23, 2000 (DE) 100 52 518.0
Sep. 15, 2001 (DE) 101 45 617.4

(51) Int. Cl. B32B 31/00; C08G 18/00

(52) U.S. Cl. 156/272.2; 528/44

(57) ABSTRACT

A reactive adhesive with a low monomer content and multistage hardening is provided. The adhesive can be solventless or solvent containing, and is a mixture of a polyurethane prepolymer (A) with a low content of monomeric isocyanate and having at least one functional group reactive with a composition containing at least one acidic hydrogen atom and at least one compound (B) containing a functional group polymerizable by irradiation. The adhesive composition can contain photoinitiators, hardeness and additives. The reactive adhesive is cured by UV radiation or electron bean radiation and by reaction of free isocyanate groups with the compositions containing at least one acidic hydrogen atom.

This invention relates to a solventless or solvent-containing low-monomer reactive adhesive curing in several stages, to its production and to its use as a laminating and coating adhesive for multilayer materials.

Adhesives based on polyurethane (PU) prepolymers which contain reactive terminal groups (reactive adhesives) are frequently used in practice for the production of composite materials, particularly multilayer films. The terminal groups are, in particular, terminal groups which are capable of reacting with water or other compounds which contain an acidic hydrogen atom. This form of reactivity enables the reactive PU polymers to be brought in the required form to the required place in the processable state (generally liquid to highly viscous) and to cure by the addition of water or other compounds containing an acidic hydrogen atom (known in this case as hardeners).

With these so-called two-component systems, the hardener is generally added immediately before application, only a limited processing time being available to the processor after addition of the hardener.

However, polyurethanes containing reactive terminal groups can also be cured without the addition of hardeners, i.e. solely by reaction with atmospheric moisture (one-component systems). One-component systems generally have the advantage over two-component systems that the user is spared the often laborious mixing of the frequently viscous components before application.

The polyurethanes terminated by reactive groups which are normally used in one-component or two-component systems include, for example, the polyurethanes containing preferably terminal isocyanate (NCO) groups.

In order to obtain NCO-terminated PU prepolymers, it is common practice to react polyhydric alcohols with an excess of monomeric polyisocyanates—generally at least predominantly diiosocyanates.

It is known that, irrespective of the reaction time, a certain quantity of the polyisocyanate used in excess is left over after the reaction. The presence of monomeric polyisocyanate is problematical, for example, when readily volatile diisocyanates have been used as the monomeric polyisocyanate. Adhesives/sealants and, in particular, PU-based hotmelt adhesives are applied at elevated temperature. Thus, the application temperatures of hotmelt adhesives are in the range from 100° C. to 200° C. while those of laminating adhesives are in the range from room temperature to 150° C. Even at room temperature, volatile diisocyanates, such as IPDI or TDI, have a significant vapor pressure. This significant vapor pressure is serious above all in the case of spray application because, in this case, significant quantities of isocyanate vapors can occur over the application unit. Isocyanate vapors are toxic in view of their irritating and sensitizing effect. The use of products with a high content of readily volatile diisocyanates involves elaborate measures on the part of the user to protect the people responsible for applying the product, more particularly elaborate measures for keeping the surrounding air fit to inhale, as legally stipulated by the maximum permitted concentration of working materials as gas, vapor or particulate matter in the air at the workplace (annually updated “MAK-Wert-Liste der Technischen Regel TRGS 900 des Bundesministeriums für Arbeit und Soziales”).

Since protective and cleaning measures generally involve considerable financial investment or costs, there is a need on the part of the user for products which—depending on the isocyanate used—have a low content of readily volatile diisocyanates.

“Readily volatile” substances in the context of the present specification are substances which have a vapor pressure of more than about 0.0007 mm Hg at 30° C. or a boiling point of less than about 190° C. (70 mPa).

If high-volatility diisocyanates, more particularly the widely used bicyclic diisocyanates, for example diphenylmethane diisocyanates, are used instead of the low-volatility diisocyanates, the PU prepolymers or adhesives based thereon generally obtained have viscosities that are normally outside the range relevant to simple methods of application. This also or additionally happens where it is intended to reduce the monomer content by reducing the NCO:OH ratio. In these cases, the viscosity of the polyurethane prepolymers can be reduced by addition of suitable solvents.

Another way of reducing viscosity is to add an excess of mono- or polyfunctional monomers, for example monomeric polyisocyanates, as so-called reactive diluents. These reactive diluents are incorporated in the coating or bond in the course of a subsequent hardening process (after addition of a hardener or by hardening under the effect of moisture).

Although the viscosity of the polyurethane prepolymer can actually be reduced in this way, the generally incomplete reaction of the reactive diluent and, in principle, the general presence of monomeric unreacted starting polyisocyanate often lead to the presence in the bond of free monomeric polyisocyanates which are capable of “migrating”, for example, within the coating or bond or, in some cases, even into the coated or bonded materials. Such migrating constituents are frequently known among experts as “migrates”. By contact with moisture, the isocyanate groups of the migrates are continuously reacted to amino groups. The content of the amines, particularly primary aromatic amines, thus formed must be below the detection limit—based on aniline hydrochloride—of 0.2 micrograms aniline hydrochloride/100 ml sample (Bundesinstitut für gesundheitlichen Verbraucherschutz und Veterinärmedizin, BGVV, nach amtlicher Sammiung von Untersuchungsverfahren nach § 35 LMBG—Untersuchung von Lebensmitteln/Bestimmung von primären aromatischen Aminen in wässrigen Prüfleb nsmitt In).

Migrates are undesirable in the packaging industry and particularly in the packaging of foods. On the one hand, the passage of the migrates through the packaging material can lead to contamination of the packaged product; on the other hand, long waiting times are necessary before the packaging material is “migrate-free” and can be used.

Another unwanted effect which can be caused by the migration of monomeric polyisocyanates is the so-called antisealing effect in the production of bags or carrier bags from laminated plastic film. The laminated plastic films often contain a lubricant based on fatty acid amides. By reaction of migrated monomeric polyisocyanate with the fatty acid amide and/or moisture, urea compounds with a melting point above the sealing temperature of the plastic films are formed on the surface of the film. This leads to the formation between the films to be sealed of a “foreign” antisealing layer which counteracts the formation of a homogeneous sealing seam.

However, problems are caused not only by the use, but also the by the marketing of reactive adhesives containing monomeric polyisocyanate. Thus, substances and preparations containing, for example, more than 0.1% free MDI or TDI come under the law on hazardous materials and have to be identified accordingly. The obligation to do so involves special measures for packaging and transportation.

Accordingly, reactive adhesives suitable for the production of composite materials are supposed to have a suitable application viscosity, but not to contain or release any volatile or migratable substances into the environment. In addition, reactive adhesives of the type in question are expected to meet the requirement that, immediately after application to at least one of the materials to be joined, they have an initial adhesion after the materials have been joined which is sufficient to prevent the composite material from separating into its original constituents or to stop the bonded materials from shifting relative to one another. However, a corresponding bond is also expected to be sufficiently flexible to withstand the various tensile and elastic stresses to which the multilayer material still at the processing stage is generally exposed without any damage to the adhesive bond or to the bonded material.

A fundamental disadvantage of the conventional solventless reactive adhesives known in the prior art is that the adhesion properties of the reactive adhesive after application are unsatisfactory on account of its low viscosity so that the bond must not be subjected to any load before final curing to ensure that the multilayer material retains the intended shape. However, this means long cure times which often make the production of multilayer materials using such reactive adhesives uneconomical.

One way of avoiding the disadvantages described above is to use a reactive adhesive system curing in several stages in the production of composite materials. The reactive adhesives used are subjected in a first stage to a rapid first curing reaction by irradiation. The strength of the bond after this first curing reaction is supposed to be such that the bonded objects or materials can be handled without difficulty. In a second curing stage, the adhesive continues to cure until it has developed the ultimate strength required.

This method is described, for example in DE 40 41 753 A1 which relates to reactive contact adhesives, to processes for their production and to their use. This document describes urethane-based coating compositions polymerizable in two stages which, through a content of UV-polymerizable acrylate groups, can be cured in a first curing stage to form a firm, but still thermoformable or embossable material which, in a second stage, undergoes irreversible hardening. To reduce viscosity, monofunctional acrylates are added to the adhesive as reactive diluents. The described adhesive has pressure-sensitive adhesive properties after irradiation. Applications for the described contact adhesive include the bonding of wood and/or plastic parts at up to about 70° C. and preferably at room temperature.

The problem addressed by the present invention was to provide a reactive adhesive with improved properties which would be suitable for the production of composite materials, more particularly for the production of film laminates.

The reactive adhesive would form a sufficiently flexible bond after the bonding process and, after complete curing, would lead to multilayer materials with excellent strength properties in relation to the bond. More particularly, the reactive adhesive would not contain any migratable or readily volatile low molecular weight compounds.

The problem addressed by the invention has been solved by a solventless or solvent-containing low-monomer reactive adhesive curing in several stages which contains at least one polyurethane prepolymer (A) with a low content of monomeric polyisocyanate (a) and at least one free functional group capable of reacting with a compound containing at least one acidic hydrogen atom, more particularly at least one isocyanate group, and at least one compound (B) containing a functional group polymerizable by irradiation.

The low-monomer reactive adhesive contains in particular a polyurethane prepolymer (A) obtainable by reaction of

a) at least one monomeric polyisocyanate (a),

b) at least one polyol (b),

c) optionally at least one compound (c) containing both functional groups polymerizable by irradiation and at least one acidic hydrogen atom and

d) optionally at least one organosilicon compound (d).

A “low-monomer reactive adhesive” in the context of the present invention is understood to be a reactive adhesive containing less than 0.1% by weight of monomeric polyisocyanate (a). A “low content of monomeric polyisocyanate” is understood to be a content of less than 0.5% by weight, preferably less than 0.3% by weight and more particularly less than 0.1% by weight of monomeric polyisocyanate (a), based on the overall composition of the polyurethane prepolymer (A).

A “polymerizable functional group” is understood to be a group which is capable of reacting with another suitable functional group by radical, anionic or cationic polymerization, polycondensation or polyaddition, resulting in an increase in the molecular weight of the molecule carrying that group. In the case of an increase in molecular weight by radical polymerization, the functional group is preferably an olefinically unsaturated double bond. In the case of an increase in molecular weight by polycondensation, the functional group may be, for example, an acid group or an alcohol group. In the case of polyaddition, suitable functional groups are, for example, isocyanate groups or epoxide groups.

By “irradiation” is meant exposure to UV light or to electron beams. A suitable functional group polymerizable by exposure to UV light or to electron beams is, for example, a group with an olefinically unsaturated double bond. According to the invention, preferred olefinically unsaturated double bonds are those present, for example, in derivatives of acrylic acid or styrene. Derivatives of acrylic acid, for example acrylates and methacrylates, are particularly suitable and preferred for the purposes of the invention.

The terms “hardening”, “curing” or the like as typically used by the expert are used fairly often hereinafter wherever reference is made to the properties of an adhesive. The “hardening” or “curing” of a composition containing polymerizable compounds is generally based on a polymerization reaction which is accompanied at least by an increase in the molecular weight of the compounds present in the composition. Normally, however, crosslinking reactions also take place at the same time. Accordingly, the terms “hardening”, “curing” or similar terms relate hereinafter to polymerization reactions which may take place in individual components of the composition considered in conjunction with the term, for example the radiation-induced polymerization of a component containing double bonds. The terms also relate to polymerization reactions which may take place among various components of the particular composition under consideration, for example the reaction of a component containing isocyanate groups with a component containing OH groups. The terms also relate to polymerization reactions which may take place between a component of the composition under consideration and a component entering the composition through an outside influence, for example the reaction between isocyanate groups and atmospheric moisture.

According to the invention, a suitable functional group capable of reacting with a compound containing at least one acidic hydrogen atom is, for example, the isocyanate group or the epoxide group, the isocyanate group being particularly preferred.

A compound containing an acidic hydrogen atom is understood to be a compound which contains an active hydrogen atom attached to an N, O or S atom and determinable by the Zerewitinoff test. The active hydrogen atom includes in particular the hydrogen atoms of water, carboxy, amino, imino and thiol groups. According to the invention, water is particularly preferred. Compounds containing amino or hydroxy groups or both or mixtures of two or more of the compounds mentioned are also preferred.

The polyurethane prepolymers (A) suitable for use in accordance with the invention can be produced by reacting at least one monomeric polyisocyanate (a) or a mixture of two or more monomeric polyisocyanates with at least one compound containing at least one acidic hydrogen atom. Suitable monomeric polyisocyanates contain on average two to at most about four isocyanate groups. In a particularly preferred embodiment of the present invention, diisocyanates are used as the monomeric polyisocyanates. Examples of suitable monomeric polyisocyanates are 1,5-naphthylene diisocyanate, 2,2′-, 2,4- and 4,4′-diphenylmethane diisocyanate (MDI), hydrogenated MDI (H₁₂MDI), allophanates of MDI, xylylene diisocyanate (XDI), tetramethyl xylylene diisocyanate (TMXDI), 4,4′-diphenyl dimethylmethane diisocyanate, di- and tetraalkyl diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether-4,4′-diphenyl diisocyanate. Sulfur-containing polyisocyanates are obtained, for example, by reaction of 2 mol hexamethylene diisocyanate with 1 mol thiodiglycol or dihydroxydihexyl sulfide. Other suitable diisocyanates are, for example, trimethyl hexamethylene diisocyanate, 1,4-diisocyanatobutane, 1,12-diisocyanatododecane and dimer fatty acid diisocyanate. Particularly suitable diisocyanates are tetramethylene, hexamethylene, undecane, dodecamethylene, 2,2,4-trimethylhexane, 2,3,3-trimethylhexamethylene, 1,3-cyclohexane, 1,4-cyclohexane, 1,3- and 1,4-tetramethyl xylene, isophorone, 4,4-dicyclohexanemethane and lysine ester diisocyanate. Tetramethyl xylylene diisocyanate (TMXDI), more particularly the m-TMXDI obtainable from Cyanamid, is most particularly preferred.

In one particular embodiment, mixtures of two or more monomeric polyisocyanates contain uretdione, isocyanurate, allophanate, biuret, iminooxathiazinedione and/or oxadiazinetrione polyisocyanates.

Allophanate polyisocyanates or polyisocyanate mixtures based on HDI, IPDI and/or 2,4′- or 4,4′-diisocyanatodicyclohexylmethane are particularly preferred. Polyisocyanates containing oxadiazinetrione groups can be produced from diisocyanate and carbon dioxide.

Suitable at least trifunctional isocyanates are polyisocyanates formed by trimerization or oligomerization of diisocyanates or by reaction of diisocyanates with polyfunctional compounds containing hydroxyl or amino groups.

Isocyanates suitable for the production of trimers are the diisocyanates mentioned above, the trimerization products of HDI, MDI, TDI or IPDI being particularly preferred.

Blocked, reversibly capped polykisisocyanates, such as 1,3,5-tris-[6-(1-methylpropylideneaminoxycarbonylamino)-hexyl]-2,4,6-trixohexahydro-1,3,5-triazine, are also suitable, preferably in admixture with other monomeric polyisocyanates.

The polymeric isocyanates formed, for example, as residue in the distillation of diisocyanates are also suitable for use. The polymeric MDI obtainable from the distillation residue in the distillation of MDI is particularly suitable.

In a preferred embodiment of the present invention, IPDI, HDI, MDI and/or TDI are used individually or in admixture as the monomeric polyisocyanate (a).

Polyols (b), for example, are suitable as the compound containing at least one acidic hydrogen atom. Polyols are compounds which contain at least two hydroxy (OH) groups as functional groups. One example of a suitable polyol (b) is a polymer selected from the group consisting of polyesters, polyethers, polyacetals or polycarbonates with a molecular weight (Mₙ) of at least about 200 g/mol or mixtures of two or more such polymers which contain terminal OH groups.

Polyesters suitable for use in accordance with the invention as polyol (b) for the production of the PU prepolymer (A) may be obtained in known manner by polycondensation of acid and alcohol components, more particularly by polycondensation of a polycarboxylic acid or a mixture of two or more polycarboxylic acids and a polyol or a mixture of two or more polyols.

Polycarboxylic acids suitable in accordance with the present invention for the production of the polyol (b) may be based on an aliphatic, cycloaliphatic, araliphatic, aromatic or heterocyclic parent compound and, besides the at least two carboxylic acid groups, may optionally contain one or more substituents which do not react in the form of a polycondensation reaction, for example halogen atoms or olefinically unsaturated double bonds. The free carboxylic acids may even be replaced by their anhydrides (where they exist) or esters with C₁₋₅ monoalcohols or mixtures of two or more thereof for the polycondensation reaction.

Suitable polycarboxylic acids are, for example, succinic acid, adipic acid, suberic acid, azelaic acid, sebacic acid, glutaric acid, glutaric anhydride, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acids or trimer fatty acids or mixtures of two or more thereof. Small quantities of monofunctional fatty acids may optionally be present in the reaction mixture.

Various polyols may be used as the diols for producing a polyester or polycarbonate suitable for use as polyol (b). Examples of such polyols are aliphatic polyols containing 2 to 4 OH groups per molecule. These OH groups may be both primary and secondary OH groups. Suitable aliphatic polyols include, for example, ethylene glycol, propane-1,2-diol, propane-1,3-diol, butane-1,4-diol, butane-1,3-diol, butane-2,3-diol, butene-1,4-diol, butine-1,4-diol, pentane-1,5-diol, and the isomeric pentanediols, pentenediols or pentinediols or mixtures of two or more thereof, hexane-1,6-diol and the isomeric hexanediols, hexenediols or hexinediols or mixtures of two or more thereof, heptane-1,7-diol and the isomeric heptane, heptene or heptinediols, octane-1,8-diol and the isomeric octane, octene or octinediols and higher homologs or isomers of the compounds mentioned, which are obtained in known manner from a step-by-step extension of the hydrocarbon chain by one CH₂ group at a time or by introducing branches into the carbon chain, or mixtures of two or more thereof.

Other suitable polyols are alcohols of relatively high functionality, such as glycerol, trimethylol propane, pentaerythritol, or sugar alcohols, such as sorbitol or glucose, and oligomeric ethers of the substances mentioned either as such or in the form of a mixture of two or more of the compounds mentioned with one another, for example polyglycerol with a degree of polymerization of about 2 to about 4. In the alcohols of relatively high functionality, one or more OH groups may be esterified with monobasic carboxylic acids containing 1 to about 20 carbon atoms, with the proviso that, on average, at least two OH groups remain intact. The alcohols of relatively high functionality mentioned may be used in pure form or, where possible, in the form of the technical mixtures obtainable in the course of their synthesis.

Polyether polyols may also be used as the polyol (b). Polyether polyols, which are to be used as the polyol (b) or for the production of polyesters suitable as the polyol (b), are preferably obtained by reaction of low molecular weight polyols with alkylene oxides. The alkylene oxides preferably contain 2 to about 4 carbon atoms. Suitable polyether polyols are, for example, the reaction products of ethylene glycol, propylene glycol, the isomeric butanediols or hexanediols, as mentioned above, or mixtures of two or more thereof with ethylene oxide, propylene oxide or butylene oxide or mixtures of two or more thereof. Other suitable polyether polyols are products of the reaction of polyhydric alcohols, such as glycerol, trimethylol ethane or trimethylol propane, pentaerythritol or sugar alcohols or mixtures of two or more thereof, with the alkylene oxides mentioned to form polyether polyols. Polyether polyols with a molecular weight (Mₙ) of about 100 to about 3,000 g/mol and preferably in the range from about 200 to about 2,000 g/mol obtainable from the reactions mentioned are particularly suitable. The polyether polyols mentioned may be reacted with the polycarboxylic acids mentioned above in a polycondensation reaction to form the polyesters suitable for use as the polyol (b).

Polyether polyols formed, for example, as described above are also suitable as the polyol (b). Polyether polyols are normally obtained by reacting a starting compound containing at least two reactive hydrogen atoms with alkylene or arylene oxides, for example ethylene oxide, propylene oxide, butylene oxide, styrene oxide, tetrahydrofuran or epichlorohydrin or mixtures of two or more thereof.

Suitable starting compounds are, for example, water, ethylene glycol, 1,2- or 1,3-propylene glycol, 1,4- or 1,3-butylene glycol, 1,6-hexanediol, 1,8-octanediol, neopentyl glycol, 1,4-hydroxymethyl cyclohexane, 2-methylpropane-1,3-diol, glycerol, trimethylol propane, hexane-1,2,6-triol, butane-1,2,4-triol, trimethylol ethane, pentaerythritol, mannitol, sorbitol, methyl glycosides, sugars, phenol, isononyl phenol, resorcinol, hydroquinone, 1,2,2- or 1,1,2-tris-(hydroxyphenyl)-ethane, ammonia, methyl amine, ethylenediamine, tetra- or hexamethylenediamine, triethanolamine, aniline, phenylenediamine, 2,4- and 2,6-diaminotoluene and polyphenyl polymethylene polyamines which can be obtained by condensing aniline with formaldehyde.

According to the invention, a polyether polyol and/or polyester polyol with a molecular weight of 200 to 4,000 and preferably in the range from 200 to 2,000 g/mole or a mixture of polyether polyols and/or polyester polyols, which satisfy the limiting criterion of molecular weight, is particularly suitable for use as the polyol (b).

In another particularly advantageous embodiment, a mixture of one or more polyester polyols and one or more polyether polyols is used as the polyol (b). The various basic polymers may differ, for example, in their molecular weight (Mₙ) or in their chemical structure or in both.

Polyether polyols modified by vinyl polymers are also suitable for use as the polyol (b). Products such as these can be obtained, for example, by polymerizing styrene or acrylonitrile or a mixture thereof in the presence of polyethers.

Polyacetals are also suitable for use as the polyol (b) or as polyol component for the production of the polyol (b). Polyacetals are understood to be compounds obtainable by reacting glycols, for example diethylene glycol or hexanediol, with formaldehyde. Polyacetals suitable for the purposes of the invention may also be obtained by polymerizing cyclic acetals.

Polycarbonates are also suitable or use as the polyol (b) or as polyol component for the production of the polyol (b). Polycarbonates may be obtained, for example, by reacting the polyols mentioned above, more particularly diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate or phosgene.

Besides the polyols (b) mentioned thus far, other compounds may also be used for the production of the polyurethane prepolymers (A) with a low monomeric polyisocyanate content and at least one free functional group capable of reacting with at least one compound containing at least one acidic hydrogen atom, for example amines and also water. The following compounds are also mentioned:

succinic acid di-2-hydroxyethylamide, succinic acid di-N-methyl-(2-hydroxyethyl)-amide, 1,4-di-(2-hydroxymethylmercapto)-2,3,5,6-tetrachlorobenzene, 2-methylene-1,3-propanediol, 2-methyl-1,3-propanediol, 3-pyrrolidino-1,2-propanediol, 2-methylene-2,4-pentanediol, 3-alkoxy-1,2-propanediol, 2-ethylhexane-1,3-diol, 2,2-dimethyl-1,3-propanediol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol and hydroxymethyl benzyl alcohol;

aliphatic, cycloaliphatic and aromatic diamines, such as ethylenediamine, hexamethylenediamine, 1,4-cyclohexylenediamine, piperazine, N-methyl propylenediamine, diaminodiphenyl sulfone, diaminodiphenyl ether, diaminodiphenyl dimethyl methane, 2,4-diamino-6-phenyl triazine, isophoronediamine, dimer fatty acid diamine, diaminodiphenyl methane, aminodiphenylamine or the isomers of phenylenediamine;

carbohydrazides or hydrazides of dicarboxylic acids;

aminoalcohols, such as ethanolamine, propanolamine, butanolamine, N-methyl ethanolamine, N-methyl isopropanolamine, diethanolamine, triethanolamine and higher di- or tri(alkanolamines);

aliphatic, cycloaliphatic, aromatic and heterocyclic mono- and diamino-carboxylic acids, such as glycine, 1- and 2-alanine, 6-aminocaproic acid, 4-aminobutyric acid, the isomeric mono- and diaminobenzoic acids and the isomeric mono- and diaminonaphthoic acids.

The polyol (b) and the monomeric polyisocyanate (a) are preferably used in a ratio of 1:>2.

In order to avoid the formation of relatively high molecular weight oligomers, the monomeric polyisocyanates are preferably used in a large stoichiometric excess in relation to the polyols. An NCO:OH ratio of 2:1 to 10:1 is preferred, an NCO:OH ratio of 3:1 to 7:1 being particularly preferred.

The reaction may be carried out, for example, in the presence of solvents. Basically, suitable solvents are any of the solvents typically used in polyurethane chemistry, more particularly esters, ketones, halogenated hydrocarbons, alkanes, alkenes and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, diisobutyl ketone, dioxane, ethyl acetate, ethylene glycol monobutyl ether acetate, ethylene glycol monoethyl acetate, 2-ethyl hexyl acetate, glycol diacetate, heptane, hexane, isobutyl acetate, isooctane, isopropyl acetate, methyl ethyl ketone, tetrahydrofuran or tetrachloroethylene or mixtures of two or more of the solvents mentioned. If the reaction components are themselves liquid or if at least one or more of the reaction components form a solution or dispersion of other, insufficiently liquid reaction components, there is no need at all to use solvents. A solventless reaction is preferred for the purposes of the invention.

To accelerate the reaction, the temperature is normally increased. In general, the reaction mixture is heated to around 40 to 80° C. The exothermic reaction which begins then provides for an increase in temperature. The temperature of the reaction mixture is kept at about 70 to about 110° C., for example at about 85 to 95° C. or more particularly at about 75 to about 85° C. If necessary, the temperature may be regulated by suitable external measures, for example heating or cooling.

Catalysts widely used in polyurethane chemistry may optionally be added to the reaction mixture to accelerate the reaction. Dibutyl tin dilaurate or diazabicyclooctane (DABCO) is preferably added. Where it is desired to use a catalyst, the catalyst is generally added to the reaction mixture in a quantity of about 0.001% by weight or about 0.01 to about 0.2% by weight, based on the mixture as a whole.

The reaction time depends upon the polyol (b) used, the monomeric polyisocyanate (a), the reaction temperature and the catalyst present, if any. The total reaction time is normally about 30 minutes to about 20 hours.

The low content of monomeric polyisocyanate (a) in the polyurethane prepolymer (A) is achieved by removing the monomeric polyisocyanate (a) from the reaction product after the reaction of at least one monomeric polyisocyanate (a) with at least one polyol (b). The purification step may be carried out by methods known per se, such as distillation, extraction, chromatography or crystallization and combinations thereof.

Where lower alkanediols are used as the polyol (b), it has proved to be effective to utilize the poor solubility of the polyurethane prepolymer (A) in certain solvents by adding a nonsolvent for the polyurethane prepolymer (A) which, at the same time, is a solvent for the monomeric polyisocyanate on completion of the polyol/polyisocyanate reaction. In this way, the polyurethane prepolymer (A) is precipitated from the reaction mixture and freed from unreacted monomeric polyisocyanate by filtration or centrifuging. This procedure should be applied in particular when the relatively non-volatile monomeric polyisocyanates, such as MDI for example, are to be used. Nonsolvents are, in particular, nonpolar aprotic organic solvents such as, for example, ethyl acetate, chlorobenzene, xylenes, toluene or, in particular, special boiling-point spirits.

Where volatile monomeric diisocyanates, such as TDI, TMXDI, IPDI, XDI or HDI for example, are used as the monomeric polyisocyanate (a), the excess monomeric polyisocyanate (a) may even be removed from the reaction mixture by distillation. To this end, distillation is preferably carried out in vacuo using a thin-layer evaporator or a thin-film evaporator. Distillation processes such as these are described, for example, in Kunststoff-Handbuch, Vol. 7, “Polyurethane”, G. W. Becker (Ed.)., Hanser-Verlag, München, 3rd Edition 1993, page 425.

Another method of removing the monomeric polyisocyanate (a) from the reaction mixture is selective extraction of the monomeric polyisocyanate (a), for example using supercritical carbon dioxide or other supercritical aprotic solvents. This extraction process is known, for example, from WO 97/46603.

The product obtained in this way is a polyurethane prepolymer (A) with a low content of monomeric polyisocyanate (a) which carries two functional terminal groups that can be polymerized by reaction with a compound containing at least one acidic hydrogen atom.

In a preferred embodiment of the invention, the polyurethane prepolymer (A) belongs to the group of NCO-terminated polyurethane prepolymers obtainable by reaction of polyols with IPDI, MDI, HDI and/or TDI.

In another preferred embodiment, the polyurethane prepolymer (A) belongs to the group of NCO-terminated PU prepolymers obtainable by reacting a mixture of a polyether polyol and/or polyester polyol having a molecular weight of about 800 to about 2,000 and a polyether polyol and/or polyester polyol having a molecular weight of about 200 to about 700 with IPDI, MDI, HDI and/or TDI.

The PU prepolymers (A) thus obtained are freed from excess monomeric polyisocyanate (a), preferably by thin-layer distillation, and have a residual content of less than 0.5% by weight of monomeric polyisocyanate after this purification step.

A compound (c) containing both at least one functional group polymerizable by irradiation and at least one acidic hydrogen atom is optionally used for the production of the PU prepolymer (A).

By irradiation is meant, in particular, exposure to UV light or to electron beams. In a particularly preferred embodiment, compound (c) contains a group with an olefinically unsaturated double bond as the functional group polymerizable by exposure to UV light or to electron beams. The molecular weight of compound (c) is in the range from 100 to 15,000 g/mol, preferably in the range from 100 to 10,000 g/mol and more particularly in the range from 100 to 8,000 g/mol.

Any of the polymeric compounds normally usable in adhesives are suitable for use as compound (c). Examples of such polymeric compounds are polyacrylates, polyesters, polyethers, polycarbonates, polyacetals, polyurethanes, polyolefins or rubber polymers, such as nitrile or styrene/butadiene rubbers, providing they contain at least one functional group polymerizable by exposure to UV light or to electron beams and at least one acidic hydrogen atom.

However, polyacrylates, polyester acrylates, epoxy acrylates or polyurethane acrylates are preferably used as compound (c) for the production of the polyurethane prepolymer (A) because the polymers mentioned make it particularly easy to attach the functional groups required in accordance with the invention to the polymer molecule.

OH-functional polyacrylates are particularly suitable for use as compound (c). OH-functional polyacrylates may be obtained, for example, by polymerizing ethylenically unsaturated monomers bearing OH groups. Such monomers are obtainable, for example, by esterification of ethylenically unsaturated carboxylic acids and difunctional alcohols, the alcohol generally being present in only a slight excess. Ethylenically unsaturated carboxylic acids suitable for this purpose are, for example, acrylic acid, methacrylic acid, crotonic acid or maleic acid. Corresponding OH-functional acrylate esters or hydroxyalkyl (meth)acrylates are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

The molar ratios between the monomeric polyisocyanate (a), the polyol (b) and optionally the compound (c) are gauged in such a way that, after the reaction of component (a) with component (b) and subsequent removal of the excess monomeric polyisocyanate (a), the PU prepolymer (A) still contains 1 to 30% by weight and preferably 1 to 20% by weight free NCO groups. If compound (c) is used in addition to (a) and (b) for the production of the PU prepolymer (A), (A) contains 1 to 10% by weight, preferably 1 to 10% by weight and more particularly 1 to 5% by weight free NCO groups. So far as the content of free NCO groups is concerned, it does not matter whether (a) is reacted with (b) or (c) in the first stage of a multistage reaction and the resulting reaction product is reacted with (c) or (b) in a second stage or whether (a), (b) and (c) are simultaneously reacted with one another in a so-called “one-pot reaction”.

The reaction ratio between components (a), (b) and (c) is selected so that both good adhesion and cohesion are obtained. The percentage content of functional groups polymerizable by exposure to UV light or electron beams determines early strength while the percentage content of functional groups capable of reacting with a compound containing at least one acidic hydrogen atom determines the ultimate strength of the bond. Good results can be obtained, for example, when 1 to 90%, preferably 5 to about 80% and more particularly 8 to about 75% of the functional groups present as terminal groups in the polymer are functional groups polymerizable by exposure to UV light or electron beams.

In certain circumstances, particularly in the presence of water, for example on damp surfaces, carbon dioxide can be given off where reactive adhesives based on NCO-terminated polyurethane prepolymers are used, resulting for example in adverse effects on the surface structure. In addition, reactive adhesives such as these often do not adhere to smooth inert surfaces, for example to surfaces of glass, ceramic, metal or the like which, in many cases, necessitates the use of a primer before application of the reactive adhesive. In order to obtain a firm and durable union between polyurethane-based reactive adhesives and the above-mentioned surfaces for example, an organosilicon compound, preferably an alkoxysilane group, is introduced into the polyurethane as a reactive terminal group.

In accordance with the conditions mentioned above, an alkoxysilane corresponding to general formula I:

X-A-Si(Z)ₙ(OR)₃₋ₙ (I)

is optionally used as component (d)—an organosilicon compound—for the production of the polyurethane prepolymer (A). In formula (I), X is a residue with at least one reactive functional group containing acidic hydrogen, for example a residue containing at least one OH—. SH—, NH—, NH₂13 , —COOH or anhydride group or a mixture of two or more such groups. In a preferred embodiment of the invention, X stands for OH, SH, H₂N(CH₂)₂—NH, (HO—C₂H₄)₂N or NH₂, A stands for CH₂, CH₂—CH₂ or CH₂—CH₂CH₂ or a linear or branched, saturated or unsaturated alkylene group containing 2 to about 12 carbon atoms or for an arylene group containing about 6 to about 18 carbon atoms or for an arylene-alkylene group containing about 7 to about 19 carbon atoms or an alkyl-, cycloalkyl- or aryl-substituted siloxane group containing about 1 to about 20 Si atoms, Z stands for —O—CH₃, —H₃, —CH₂—CH₃ or for a linear or branched, saturated or unsaturated alkyl group or alkoxy group containing 2 to about 12 carbon atoms and R stands for —CH₃, —CH₂—CH₃, —CH₂—CH₂—CH₃ or a linear or branched, saturated or unsaturated alkyl group containing 2 to about 12 carbon atoms. In a preferred embodiment of the invention, the variable n has a value of 0,1 or 2.

Examples of starting materials suitable as component (d) are H₂N—(CH₂)₃—Si(O—CH₂—CH₃)₃, HO—CH(CH₃)—CH₂—Si(OCH₃)₃, HO—(CH₂)₃—Si(O—CH₃)₃, HO—CH₂—CH₂—O—CH₂—CH₂—Si(OCH₃), (HO—C₂H₄)₂N—(CH₂)₃—Si(O—CH₃)₃, HO—(C₂H₄—O)₃C₂H₄—N(CH₃)—(CH₂)₃—Si(O—C₄H₉)₃, H₂N—CH₂—C₆H₄—CH₂—CH₂—Si(O—CH₃)₃, HS—(CH₂)₃Si(O—CH₃)₃, H₂N—(CH₂)₃—NH—(CH₂)₃—Si(OCH₃)₃, H₂N—CH₂—CH₂—NH—(CH₂)₂—Si(OCH₃)₃, H₂N—(CH₂)₂—NH—(CH₂)₃—Si(OCH₃)₃, HO—CH(C₂H₅)—CH₂—Si(OC₂H₅)₃, HO(CH₂)₃—Si(O—C₂H₅)₃, HO—CH₂—CH₂—O—CH₂—Si(OC₂H₅)₃, (HO—C₂H₄)₂—N—(CH₂)₃—Si(OC₂H₅)₃, H₂N—CH₂—C₆H₄—CH₂—CH₂—Si(O—C₂H₅)₃, HS—(CH₂)₃—Si(O—C₂H₅)₃, H₂N—(CH₂)₃NH—(CH₂)₃—Si(OC₂H₅)₃, H₂N—CH₂—CH₂—NH—(CH₂)₂—Si(O—C₂H₆)₃, H₂N—(CH₂)₂—NH(CH₂)₃—Si(OC₂H₅)₃.

In a preferred embodiment, as described above, the monomeric polyisocyanate (a) is first reacted with the polyol (b) in a multistage reaction to form a reaction product preferably terminated by NCO groups. The excess monomeric polyisocyanate (a) is then removed by one of the described purification processes, preferably by thin-layer distillation. The free NCO groups of the reaction product of monomeric polyisocyanate (a) with polyol (b) are optionally reacted with the compound (c), which contains both functional groups polymerizable by irradiation and at least one acidic hydrogen atom, and/or with the alkoxysilane (d).

In this case, too, it is also possible to carry out a one-pot reaction by reacting components (a) to (d) inclusive in a single stage and then removing the excess monomeric polyisocyanate by one of the purification methods described above. Variants of the multistage reaction described above are also possible—for example a combination in the sequence (a)+(c)+(b)+(d) with subsequent removal of the excess monomeric polyisocyanate by one of the purification methods described above.

The optionally alkoxysilane-terminated polyurethane prepolymer (A) preferably still containing free NCO groups is then mixed with the other components.

The reactive adhesives according to the invention contain at least one compound which has at least one and preferably two functional groups polymerizable by exposure to UV light or electron beams as compound (B). Compound (B) contains at least one group with an olefinically unsaturated double bond as the functional group(s) polymerizable by exposure to UV light or electron beams.

Acrylate or methacrylate esters with a functionality of two or more are particularly suitable as compound (B). Acrylate or methacrylate esters such as these include, for example, esters of acrylic or methacrylic acid with aromatic, aliphatic or cycloaliphatic polyols and acrylate esters of polyether alcohols.

Any of the large number of polyols already described as polyol (b) for the production of the PU prepolymer (A) may be used as polyols for the production of an acrylate or methacrylate ester suitable for use as compound (B).

Acrylate esters of aliphatic polyols containing 2 to about 40 carbon atoms include, for example, neopentyl glycol di(meth)acrylate, 1,6-hexanediol di(meth)acrylate, trimethylol propane tri(meth)acrylate, pentaerythritol tetra(meth)acrylate and (meth)acrylate esters of sorbitol and other sugar alcohols. These (meth)acrylate esters of aliphatic or cycloaliphatic diols may be modified with an aliphatic ester or an alkylene oxide. The acrylates modified by an aliphatic ester comprise, for example, neopentyl glycol hydroxypivalate di(meth)acrylate, caprolactone-modified neopentyl glycol hydroxypivalate di(meth)acrylates and the like. The alkylene oxide-modified acrylate compounds include, for example, ethylene oxide-modified neopentyl glycol di(meth)acrylates, propylene oxidemodified neopentyl glycol di(meth)acrylates, ethylene oxide-modified 1,6-hexanediol di(meth)acrylates or propylene oxide-modified hexane-1,6-diol di(meth)acrylates or mixtures of two or more thereof.

Acrylate monomers based on polyether polyols comprise, for example, neopentyl glycol-modified (meth)acrylates, trimethylol propane di(meth)acrylates, polyethylene glycol di(meth)acrylates, polypropylene glycol di(meth)acrylates and the like. Trifunctional and higher acrylate monomers comprise, for example, trimethylol propane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]-isocyanurate, caprolactone-modified tris[(meth)acryloxyethyl]-isocyanurates or trimethylol propane tetra(meth)acrylate or mixtures of two or more thereof.

Of the above-mentioned difunctional, trifunctional or higher acrylate monomers which may be used in accordance with the invention as component B, di-, tri- and tetrapropylene glycol diacrylate, neopentyl glycol propoxylate di(meth)acrylate, trimethylol propane tri(meth)acrylate, trimethylolpropane monoethoxytri(meth)acrylate and pentaerythritol triacrylate are preferred.

(Meth)acrylate esters based on polyols containing urethane groups can be produced by reacting the polyols (b) already mentioned with the monomeric polyisocyanates already mentioned to form at least partly OH-terminated polyurethane prepolymers which are esterified with (meth)acrylic acid to form the corresponding mono- or diesters.

In one particular embodiment, a compound obtainable by reacting (a) with (c) is used as compound (B). Isocyanatourethane acrylates obtainable by reacting isocyanurates, for example based on HDI, with acrylate polyols are particularly preferred.

Compounds which are flowable at room temperature, especially esters of acrylic or methacrylic acid, are particularly suitable as so-called reactive diluents, compound (B). Particularly suitable compounds are, for example, the acrylates or methacrylates of aromatic, cycloaliphatic, aliphatic, linear or branched C₄₋₂₀ monoalcohols or of corresponding ether alcohols, for example n-butyl acrylate, 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate.

Compound (B) makes up as much as about 80% by weight of the reactive adhesive according to the invention, but preferably less, for example about 40% by weight, 30% by weight or about 20% by weight. The use of smaller quantities is equally possible. Thus, the reactive adhesive according to the invention may also contain only 10% by weight or a quantity of about 0.5 to about 8% by weight of compound (B).

In addition to PU prepolymer (A) and compound (B), the reactive adhesive may contain at least one photoinitiator which initiates the polymerization of olefinically unsaturated double bonds under UV irradiation as component (C).

Accordingly, a photoinitiator capable of initiating the radical polymerization of olefinically unsaturated double bonds on exposure to light with a wavelength of about 215 to about 480 nm is generally used as component C. In principle, any commercially available photoinitiators which are compatible with the adhesive according to the invention, i.e. which form at least substantially homogeneous mixtures, may be used as component (C) for the purposes of the present invention.

Commercially available photoinitiators such as these are, for example, any Norrish-type I fragmenting substances, for example benzophenone, camphor quinone, Quantacure (a product of International Bio-Synthetics), Kayacure MBP (a product of Nippon Kayaku), Esacure BO (a product of Fratelli Lamberti), Trigonal 14 (a product of Akzo), photoinitiators of the Irgacure®, Darocure® or Speedcure® series (products of Ciba Geigy), Darocure® 1173 and/or Fi-4 (made by the Eastman Company). Of these, Irgacure® 651, Irgacure® 369, Irgacure® 184, Irgacure® 907, Irgacure® 1850, Irgacure® 1173 (Darocure®) 1173), Irgacure®) 1116, Speedcure®) EDB, Speedcure® ITX, Irgacure® 784 or Irgacure® 2959 or mixtures of two or more thereof are particularly suitable. Also suitable is 2,4,6-trimethylbenzene diphenyl phosphine oxide (Lucirin TPO, a product of BASF AG) which may also be used in admixture with one or more of the photoinitiators mentioned above.

Conventional low molecular weight photoinitiators may contribute to the formation of “migrates” in laminates. Migrates include the photoinitiators themselves present in the reactive adhesive and also fragments of the photoinitiators which can be formed on exposure of the adhesive to UV light. In certain circumstances, for example in the production of laminates intended for the packaging of foods, the presence of migratable compounds in the reactive adhesive should be avoided. The content of migratable compounds in the reactive adhesive according to the invention can generally be further reduced if the photoinitiator has a molecular weight which makes migration very difficult or even impossible.

Accordingly, in a preferred embodiment, component (C) at least partly contains a photoinitiator with a molecular weight of more than about 200 g/mol. Commercially available photoinitiators which meet this requirement are, for example, lrgacure® 651, Irgacure® 369, Irgacure® 907, Irgacure® 784, Speedcure® EDB and Speedcure® ITX.

However, photoinitiators which meet the above-stated requirement in regard to their molecular weight can also be obtained by reacting a low molecular weight photoinitiator containing at least one acidic hydrogen atom, for example an amino group or an OH group, with a high molecular weight compound containing at least one isocyanate group (polymer-bound photoinitiators). Compounds containing more than one photoinitiator molecule, for example two, three or more photoinitiator molecules, are preferably used as component (C). Compounds such as these can be obtained, for example, by reacting a polyol with suitable polyisocyanates and photoinitiators containing at least one acidic hydrogen atom.

Suitable polyols are any of the polyols mentioned above, but especially neopentyl glycol, glycerol, trimethylol propane, pentaerythritol and alkoxylation products thereof with C₂.₄ alkylene oxides. Other suitable and, according to the invention, particularly preferred polyols are the reaction products of trihydric alcohols with caprolactone, for example the reaction product of trimethylol propane with caprolactone (Capa 305, a product of Interox, Cheshire, UK; molecular weight (Mₙ)=540).

In another preferred embodiment of the present invention, component (C) contains a photoinitiator obtainable by reacting an at least trihydric alcohol with caprolactone to form a polycaprolactone containing at least three OH groups with a molecular weight of about 300 to about 900 and then linking the polycaprolactone to 1-[4-(2-hydroxyethoxy)-phenyl]-2-hydroxy-2-methylpropan-1-one by means of a monomeric polyisocyanate.

Suitable monomeric polyisocyanates for reaction with the polyols mentioned are, for example, any of the monomeric polyisocyanates (a) mentioned in the present specification. However, the 2,4-isomer and the 2,6-isomer of toluene diisocyanate (TDI) are particularly preferred, the isomers being used either in their pure form or in the form of a mixture.

Suitable photoinitiators for producing the polymer-bound photoinitiators are any photoinitiators which contain an acidic hydrogen atom. 1-[4-(2-hydroxyethoxy)-phenyl]-2-hydroxy-2-methylpropan-1-one (Irgacure® 2959), which has one primary OH group, is particularly preferred for the purposes of the present invention.

The photoinitiators used in component (C) may also be prepared by using a small quantity of photoinitiator molecules containing at least one acidic hydrogen atom in the production of component A. In this way, the photoinitiator is attached to a molecule of the PU prepolymer (A).

The photoinitiator may also be attached to a polymer chain, for example to PU prepolymer (A), by adding the photoinitiator containing a corresponding functional group to the reactive adhesive in monomeric form and then reacting it with a corresponding polymeric component, for example PU prepolymer (A), for example during storage of the reactive adhesive.

It is also possible to provide the photoinitiator with a functional group polymerizable by exposure to UV light or to electron beams, in which case the functional group polymerizable by exposure to UV light or to electron beams can be attached to the photoinitiator, for example by reaction of the photoinitiator with an unsaturated carboxylic acid. Suitable unsaturated carboxylic acids are, for example, acrylic acid and methacrylic acid. The reaction products of lrgacure® 2959 with acrylic acid or methacrylic acid are particularly suitable for the purposes of the invention.

Accordingly, a compound which contains both a photoinitiator and a functional group polymerizable by exposure to UV light or to electron beams or a functional group capable of reacting with a compound containing at least one acidic hydrogen atom may be used as component (C).

The reactive adhesive according to the invention contains component (C) in a quantity of 0 to 15% by weight, based on the reactive adhesive as a whole.

After a first curing stage involving exposure, for example, to electron beams or UV light (in conjunction with a corresponding photoinitiator as component (C)), the reactive adhesive according to the invention, as a one-component reactive adhesive, can be cured to the ultimate strength required by the effect of atmospheric moisture. If, however, the reactive adhesive is intended to develop a certain ultimate strength very quickly, i.e. to harden at a high hardening rate, for example to enable the bonded materials to be rapidly further processed, the hardening rate based on hardening by atmospheric moisture may be too low. In such cases, a hardener (D) may be added to the reactive adhesive before processing.

Accordingly, the present invention also relates to a reactive adhesive which, in the form of a two-component reactive adhesive, contains as hardener (D) 0 to 60% by weight of a compound containing at least two functional groups each having at least one acidic hydrogen atom. The molecular weight of (D) is in the range from 50 to 10,000 g/mol, preferably in the range from 50 to 6,000 g/mol and more particularly in the range from 50 to 3,000 g/mol. The hardener (D) is preferably a compound containing at least two functional groups each having at least one acidic hydrogen atom or a mixture of two or more such compounds which are capable of reacting with the corresponding functional group of PU prepolymer (A). In the context of the present specification, the corresponding functional groups of PU prepolymer (A) are understood to be any functional groups present in PU prepolymer (A) which are not polymerizable by exposure to radiation under the conditions according to the invention, more particularly isocyanate groups.

Suitable functional groups having at least one acidic hydrogen atom which are reactive with the corresponding functional groups of PU prepolymer (A) are, in particular, primary or secondary amino groups, mercapto groups or OH groups. The compounds suitable as hardener (D) may contain amino groups, mercapto groups or OH groups either as such or in admixture.

The reactive adhesive according to the invention preferably contains a compound with at least two OH groups as the hardener (D).

The compounds usable in the hardener (D) generally have a functionality of at least about two. The hardener (D) preferably contains a certain percentage of compounds with a higher functionality, for example with a functionality of three, four or more. The total (average) functionality of the hardener (D) is, for example, about two (for example where only difunctional compounds are used as the hardener (D)) or more, for example about 1.2, 2.2, 2.5, 2.7 or 3. The hardener (D) may have an even higher functionality, for example about four or more.

The hardener (D) present contains a polyol bearing at least two OH groups. Any of the polyols (b) mentioned in the present specification and reaction products or mixtures of the polyols (b) with (a), (c) or (d) may be used as the hardener (D) providing they satisfy the limiting criterion of the upper molecular weight limit.

The hardener (D) is generally used in such a quantity that the ratio of functional groups of component (A) reactive with the hardener (D) to groups of the hardener (D) reactive with corresponding functional groups of component (A) is about 5:1 to about 1:1 and more particularly about 2:1 to about 1:1.

The reactive adhesive according to the invention generally has a viscosity of 100 mPa.s to 26,000 mPa.s at 70° C. (Brookfield viscosity, RVT DV-II Digital Viscosimeter, spindle 27). In preferred embodiments of the invention, the viscosity of the adhesive is selected so that the adhesive has a viscosity at typical application temperatures of about 1,000 mPas to about 5,000 mPas (Brookfield viscosity, RVT DV-1II Digital Viscosimeter, spindle 27). Typical application temperatures are, for example, about 25 to about 70° C. in the production of flexible packaging films, about 70 to about 80° C. in the lamination of high-gloss films and about 80 to about 130° in textile applications.

The reactive adhesive according to the invention may optionally contain additives as component (E). The additives may make up as much as about 50% by weight of the adhesive as a whole.

The additives suitable for use as component (E) in accordance with the invention include, for example, plasticizers, stabilizers, antioxidants, adhesion promoters, dyes and fillers.

The plasticizers used are, for example, plasticizers based on phthalic acid, more especially dialkyl phthalates, preferred plasticizers being phthalic acid esters which have been esterified with a linear alkanol containing about 6 to about 14 carbon atoms. Diisononyl or diisotridecyl phthalate is particularly preferred.

Other suitable plasticizers are benzoate plasticizers, for example sucrose benzoate, diethylene glycol dibenzoate and/or diethylene glycol benzoate, in which around 50 to around 95% of all the hydroxyl groups have been esterified, phosphate plasticizers, for example t-butyl phenyl diphenyl phosphate, polyethylene glycols and derivatives thereof, for example diphenyl ethers of poly(ethylene glycol), liquid resin derivatives, for example the methyl ester of hydrogenated resin, vegetable and animal oils, for example glycerol esters of fatty acids and polymerization products thereof.

The stabilizers or antioxidants suitable for use as additives in accordance with the present invention include phenols, sterically hindered phenols of high molecular weight (Mₙ), polyfunctional phenols, sulfur- and phosphorus-containing phenols or amines. Phenols suitable for use as additives in accordance with the invention are, for example, hydroquinone, hydroquinone methyl ether, 2,3-(di-tert.butyl)-hydroquinone, 1,3,5-trimethyl-2,4,6-tris-(3,5-di-tert.butyl-4-hydroxybenzyl)-benzene; butyl hydroxytoluene (BHT), pentaerythritol tetrakis-3-(3,5-ditert.butyl-4-hydroxyphenyl)propionate; n-octadecyl-3,5-ditert.butyl-4-hydroxyphenyl)-propionate; 4,4-methylene-bis-(2,6-di-tert.butylphenol); 4,4-thiobis-(6-tert.butyl-o-cresol); 2,6-di-tert.butylphenol; 2,6-di-tert.butyl-n-methylphenol; 6-(4-hydroxyphenoxy)-2,4-bis-(n-octylthio)-1,3,5-triazine; di-n-octadecyl-3,5-di-tert.butyl-4-hydroxybenzyl phosphonates; 2-(n-octylthio)-ethyl-3,5-ditert.butyl-4-hydroxybenzoate; and sorbitol hexa[3-(3,5-ditert.butyl-4-hydroxyphenyl)-propionate]; and p-hydroxydiphenylamine or N,N′-diphenylenediamine or phenothiazine.

The reactive adhesive according to the invention may contain adhesion promoters as component (E). Adhesion promoters are substances which improve the adhesive strength of materials to be combined with one another. In particular, adhesion promoters are intended to improve the ageing behavior of bonds in humid atmospheres. Typical adhesion promoters are, for example, ethylene/acrylamide comonomers, polymeric isocyanates, reactive organosilicon compounds and phosphorus derivatives. According to the invention, the phosphorus derivatives disclosed in WO 99/64529 (page 7, line 14 to page 9, line 5), for example 2-methacryloyloxyethyl phosphate, bis-2-(methacryloyloxyethyl)-phosphate or mixtures thereof, are preferably used as adhesion promoters. (Meth)acrylic compounds containing carboxylic acids may also be used as adhesion promoters. Compounds of this type are disclosed, for example, in WO 01/16244 (page 7, line 7 to page 8, line 31) or in WO 00/29456 (page 11, line 15 to page 12, line 2). Commercially available products are obtainable, for example, from UCB Chemicals, B-1 620 Drogenbos, Belgium as products of the “Ebecryl” class, for example Ebecryl 168 or Ebecryl 170.

Other additives (E) may be incorporated in the reactive adhesives according to the invention in order to vary certain properties. These other additives include, for example, dyes, such as titanium dioxide, fillers, such as talcum, clay and the like. The adhesives according to the invention may optionally contain small quantities of thermoplastic polymers, for example ethylene/vinyl acetate (EVA), ethylene/acrylic acid, ethylene/methacrylate and ethylene/n-butyl acrylate copolymers which optionally impart additional flexibility, toughness and strength to the adhesive. Certain hydrophilic polymers may also be added, including for example polyvinyl alcohol, hydroxyethyl cellulose, hydroxypropyl cellulose, polyvinyl methyl ether, polyethylene oxide, polyvinyl pyrrolidone, polyethyl oxazolines or starch or cellulose esters, more particularly the acetates with a degree of substitution of less than 2.5. These hydrophilic polymers increase the wettability of the adhesives for example.

The solventless or solvent-containing low-monomer reactive adhesives according to the invention which cure in several stages preferably contain:

I) 10 to 98% by weight and preferably 10 to 80% by weight of at least one polyurethane prepolymer (A),

II) 0.5 to 80% by weight and preferably 1 to 40% by weight of at least one compound (B),

III) 0 to 15% by weight and preferably 1 to 8% by weight of at least one photoinitiator (C),

IV) 0 to 60% by weight and preferably 0 to 40% by weight of at least one hardener (D),

V) 0 to 50% by weight and preferably 1 to 20% by weight of additives (E),

the sum total of the constituents coming to 100% by weight.

Depending on the application envisaged, the reactive adhesive according to the invention may contain up to 60% by weight of any of the inert solvents already mentioned in connection with the production of polyurethane prepolymer (A).

The reactive adhesives according to the invention may be produced by any of the standard methods known to the expert on the production of polymeric mixtures.

Basically, the reactive adhesive according to the invention may be used in the bonding of various materials. Materials suitable for bonding include, for example, wood, metal, glass, plant fibers, stone, paper, cellulose hydrate, plastics, such as polystyrene, polyethylene, polypropylene, polyethylene terephthalate, polyvinyl chloride, copolymers of vinyl chloride and vinylidene chloride, copolymers of vinyl acetate olefins, polyamides, or metal foils, for example of aluminium, lead or copper.

In a preferred embodiment, the reactive adhesive according to the invention is used in the production of multilayer materials. Through a content of less than 0.1% by weight of monomeric polyisocyanate, the reactive adhesive according to the invention is particularly suitable for multilayer materials used in the packaging of foods.

Accordingly, the present invention also relates to a process for the production of multilayer materials which is characterized in that a reactive adhesive according to the invention is used. In another preferred embodiment, the multilayer materials which can be produced using the reactive adhesive according to the invention are film laminates obtainable by the part- or whole-surface bonding of films.

The reactive adhesives according to the invention may be applied to the materials, particularly films, to be bonded by machines typically used for such purposes, for example by conventional laminating machines. The application of the reactive adhesive in liquid form to a film to be bonded to form a laminate is particularly suitable. The film thus coated with the reactive adhesive is laminated, optionally under pressure, with at least a second film and then exposed to UV light or electron beams.

In one particular embodiment of the process, the film coated with the reactive adhesive is first transferred to an irradiation zone where the polymerization reaction, i.e. crosslinking of the individual components, is initiated by exposure to UV radiation or electron beams. The reactive adhesive according to the invention becomes tacky, for example develops contact- or, preferably, pressure-sensitive adhesive properties, under the effect of the irradiation and the accompanying crosslinking reaction of the individual components present in the reactive adhesive. After irradiation, the first film coated with the irradiated reactive adhesive is laminated, optionally under pressure, with at least a second film. This procedure is advantageous particularly when two films that are not permeable to the radiation necessary for initiating polymerization are to be bonded to one another. Whereas no other auxiliaries are required where crosslinking is initiated by electron beams, polymerization by UV light requires the presence of a photoinitiator (component E).

The described bonding and laminating processes may be repeated several times so that laminates consisting of more than two bonded layers can be produced.

The described bonding and laminating processes are normally carried out in an inert gas atmosphere, i.e. in the presence of such inert gases as nitrogen. However, the described bonding and laminating processes with the reactive adhesive according to the invention may also readily be carried out in a normal atmosphere such as typically prevails in the production shops.

Accordingly, the present invention also relates to a multilayer material produced by the process according to the invention using the reactive adhesive according to the invention.

The reactive adhesive according to the invention may be applied to the surfaces to be bonded by any suitable process, for example by spraying, knife coating, three/four roller application units where a solventless reactive adhesive is used or two-roller application units where a solvent-containing reactive adhesive is used.

The invention is illustrated by the following Examples.

### EXAMPLES

### I. Production and Properties of the PU Prepolymers

PU Prepolymer (1):

Low-monomer prepolymer based on an MDI-terminated polyether

Reaction of monomeric polyisocyanate (a) with polyol (b) to form NCO adduct (1):

In a three-necked flask equipped with a stirrer, thermometer and drying tube, 787.20 g polyether diol (OH value: 130.2) were heated to 40° C. and 712.80 g liquid MDI were added. The mixture was left to react for 1 hour at 70-75° C. The residual monomers were then distilled off in a thin-layer distillation apparatus.

NCO value of the end product: 6.08% by weight; monomer content: <0.1% by weight; Brookfield viscosity at 50° C.: 8,300 mPa.s.

Reaction with a compound (c):

In a three-necked flask equipped with a stirrer, thermometer and drying tube, 333.66 g of the above-mentioned NCO adduct (1) were heated with stirring to 70° C. and 0.5 g 2,6-di-tert.butyl-4-methylphenol were added. After 5 minutes, 16.35 g hydroxypropyl acrylate were added. The mixture was left to react for one hour at 70-75° C. and then poured into a container.

NCO value of the end product: 4.0% by weight (theoretical value: 4.3% by weight), Brookfield viscosity at 70° C.: 3,900 mPa.s.

PU Prepolymer (2):

Low-monomer prepolymer based on an MDI-terminated polyether

Reaction with a compound (c):

In a three-necked flask equipped with a stirrer, thermometer and drying tube, 273.21 g of the above-mentioned NCO adduct (1) were heated with stirring to 70° C. and 0.5 g 2,6-di-tert.butyl-4-methylphenol were added. After 5 minutes, 26.79 g hydroxypropyl acrylate were added. The mixture was left to react for two hours at 70-75° C. and then poured into a container.

NCO value of the end product: 2.4% by weight (theoretical value: 2.8% by weight), Brookfield viscosity at 70° C.: 8,600 mPa.s.

PU Prepolymer (3):

Low-monomer polyurethane prepolymer (A) based on an TDI-terminated polyether

Reaction of monomeric polyisocyanate (a) with polyol (b) to form NCO adduct (2):

In a three-necked flask equipped with a stirrer, thermometer and drying tube, 951.15 g polyether diol (OH value: 185) were heated to 50° C. and 548.85 g 2,4-TDI were added. The mixture was left to react for 2 hours at 70-75° C. The residual monomers were then distilled off in a thin-layer distillation apparatus.

NCO value of the end product: 8.52% by weight; monomer content: <0.1 TDI; Brookfield viscosity at 50° C.: 6,200 mPa.s.

Reaction with a compound (c):

In a three-necked flask equipped with a stirrer, thermometer and drying tube, 263.76 g of the above-mentioned NCO adduct (2) were heated with stirring to 40° C. and 0.5 g 2,6-di-tert.butyl-4-methylphenol were added. After 10 minutes, 36.24 g hydroxypropyl acrylate were added. The mixture was left to react for four hours at 70-75° C. and then poured into a container.

NCO value of the end product: 3.5% by weight (theoretical value: 3.75% by weight), Brookfield viscosity at 70° C.: 4,000 mPa.s.

PU Prepolymer (4):

Low-monomer polyurethane prepolymer (A) based on an HDI-terminated polyether

Reaction of monomeric polyisocyanate (a) with polyol (b) to form NCO adduct (3):

In a three-necked flask equipped with a stirrer, thermometer and drying tube, 599.40 g polyether diol (OH value: 334.1) were heated to 70° C. and 900.60 g HDI were added. The mixture was left to react for 2 hours at 100° C. The residual monomers were then distilled off in a thin-layer distillation apparatus.

NCO value of the end product: 12.48% by weight; monomer content: <0.5% HDI; Brookfield viscosity at 20° C.: 5,100 mPa.s.

Reaction with a compound (c):

In a three-necked flask equipped with a stirrer, thermometer and drying tube, 249.75 g of the above-mentioned NCO adduct were heated with stirring to 70° C. and 0.5 g 2,6-di-tert.butyl-4-methylphenol were added. After 10 minutes, 50.25 g hydroxypropyl acrylate were added. The mixture was left to react for three hours at 70-75° C. and then poured into a container.

NCO value of the end product: 3.9% by weight (theoretical value: 5.2% by weight), Brookfield viscosity at 70° C.: 1,400 mPa.s.

PU Prepolymer (5):

Low-monomer polyurethane prepolymer based on TDI and MDI-terminated polyether and polyester prepolymers

Reaction of monomeric polyisocyanate (a) with polyol (b) to form NCO adduct (4):

In a three-necked flask equipped with a stirrer, thermometer and drying tube, 556.20 g polyester diol (OH value: 137.0), 203.58 g polyether diol 1 (OH value: 267.0) and 463.50 g polyether diol 2 (OH value: 110) and 88.20 g polyester diol 2 (OH value: 110.0) were heated to 50° C. and 420.66 g 2,4-TDI were added. The mixture was left to react for 90 minutes at ca. 110° C. 67.86 g of a dipropylene glycol-4,4′-MDI adduct (21.55% NCO) were then added. The mixture was left to react for one hour at 85° C. and then poured into a container.

NCO value of the end product: 4.2% by weight; monomer content: <0.5% by weight; Brookfield viscosity at 70° C.: 5,100 mPa.s.

Reaction with a compound (c):

In a three-necked flask equipped with a stirrer, thermometer and drying tube, 749.28 g of the above-mentioned NCO adduct (4) were heated with stirring to 70° C. and 0.5 g 2,6-di-tert.butyl-4-methylphenol were added. After five minutes, 50.72 g hydroxypropyl acrylate were added. The mixture was left to react for three hours at 70-75° C. and then poured into a container.

NCO value of the end product: 1.9% by weight (theoretical value: 2.0%), Brookfield viscosity at 70° C.: 7,000 mPa.s.

PU Prepolymer (6):

Low-monomer prepolymer based on an MDI-terminated polyether

Preparation of the NCO adduct:

In a three-necked flask equipped with a stirrer, thermometer and drying tube, 1041.84 g polyether diol (OH value: 130.2) were heated to 45° C. and 758.16 g liquid MDI were added. The mixture was left to react for 1 hour at 70-75° C. The reaction product was then divided in two.

The residual monomers were distilled off from one part in a thin-layer distillation apparatus. NCO value of the end product: 5.83% by weight; monomer content: 0.1% by weight MDI; Brookfield viscosity at 50° C.: 7,600 mPa.s. The part that was not distilled off contained 8.9% by weight MDI, NCO value: 8.19% by weight, Brookfield viscosity at 50° C.: 5,700 mPa.s.

Production of the low-monomer dual-cure prepolymer (1): (reaction with (c)):

In a three-necked flask equipped with a stirrer, thermometer and drying tube, 382.28 g of the above-mentioned NCO adduct distilled off were heated with stirring to 70° C. and 0.2 g 2,6-di-tert.butyl-4-methylphenol were added. After five minutes, 17.52 g hydroxypropyl acrylate were added. The mixture was left to react for one hour at 70-75° C. and then poured into container.

NCO value of the end product: 3.95% by weight (theoretical value: 4.14%), monomer content: 0.06% by weight MDI, Brookfield viscosity at 70° C.: 2,400 mPa.s.

Production of the standard-monomer dual-cure prepolymer (2): (reaction with (c)):

In a three-necked flask equipped with a stirrer, thermometer and drying tube, 375.64 g of the above-mentioned NCO adduct not distilled off were heated with stirring to 70° C. and 0.2 g 2,6-di-tert.butyl-4-methylphenol were added. After five minutes, 24.16 g hydroxypropyl acrylate were added. The mixture was left to react for one hour at 70-75° C. and then poured into a container.

NCO value of the end product: 5.45% by weight (theoretical value: 5.78%), monomer content: 4.3% by weight MDI, Brookfield viscosity at 70° C.: 1,900 mPa.s.

PU Prepolymer (7):

Low-monomer prepolymer based on an HDI-terminated polyether

In a three-necked flask equipped with a stirrer, thermometer and drying tube, 867.60 g polyether diol (OH value: 334.1) were heated to 70° C. and 932.40 g HDI were added. The mixture was left to react for two hours at 100-110° C. The reaction product was then divided in two.

The residual monomers were distilled off from one part in a thinlayer distillation apparatus. NCO value of the end product: 12.50% by weight; monomer content: <0.5% by weight HDI; Brookfield viscosity at 20° C.: 5,300 mPa.s. The part that was not distilled off contained 4.9% by weight HDI, NCO value: 14.32% by weight, Brookfield viscosity at 20° C.: 4,900 mPa.s.

Production of the low-monomer dual-cure prepolymer (3): (reaction with (c)):

In a three-necked flask equipped with a stirrer, thermometer and drying tube, 334.16 g of the above-mentioned NCO adduct distilled off were heated with stirring to 70° C. and 0.2 g 2,6-di-tert.butyl-4-methylphenol were added. After five minutes, 65.64 g hydroxypropyl acrylate were added. The mixture was left to react for three hours at 70-75° C. and then poured into a container.

NCO value of the end product: 5.1% by weight (theoretical value: 5.22%), monomer content: 0.05% by weight HDI, Brookfield viscosity at 40° C.: 1,900 mPa.s.

Production of the standard-monomer dual-cure prepolymer (4): (reaction with (c)):

In a three-necked flask equipped with a stirrer, thermometer and drying tube, 326.36 g of the above-mentioned NCO adduct not distilled off were heated with stirring to 70° C. and 0.2 g 2,6-di-tert.butyl-4-methylphenol were added. After five minutes, 73.44 g hydroxypropyl acrylate were added. The mixture was left to react for one hour at 70-75° C. and then poured into a container.

NCO value of the end product: 5.60% by weight (theoretical value: 5.84%), monomer content: 1.4% by weight HDI, Brookfield viscosity at 40° C.: 1,700 mPa.s.

### II. Production and Properties of the Reactive Adhesives

Reactive Adhesive (1):

1-component reactive adhesive based on PU prepolymer (1)

85.5 g PU prepolymer (1) were stirred with 9.5 g tripropylene glycol diacrylate (compound (B)) and 5 g Irgacure 184 (photoinitiator (C)) in the absence of moisture at 70° C. until a homogeneous mixture was obtained. Brookfield viscosity at 70° C.: 2,100 mPa.s.

Reactive Adhesive (2):

1-component reactive adhesive based on PU prepolymer (2)

76 g PU prepolymer (2) were stirred with 19 g tripropylene glycol diacrylate (compound (B)) and 5 g Irgacure 184 (photoinitiator (C)) in the absence of moisture at 70° C. until a homogeneous mixture was obtained. Brookfield viscosity at 70° C.: 1,800 mPa.s.

Reactive Adhesive (3):

1-component reactive adhesive based on PU prepolymer (3)

85.5 g PU prepolymer (3) were stirred with 9.5 g tripropylene glycol diacrylate (compound (B)) and 5 g Irgacure 184 (photoinitiator (C)) in the absence of moisture at 70° C. until a homogeneous mixture was obtained. Brookfield viscosity at 70° C.: 4,300 mPa.s.

Reactive Adhesive (4):

2-component reactive adhesive based on PU prepolymer (4)

86.75 g PU prepolymer (4) were stirred with 4.56 g Irgacure 184 (photoinitiator (C)) in the absence of moisture at 70° C. until a homogeneous mixture was obtained. Brookfield viscosity at 70° C.: 1,400 mPa.s.

8.69 g of a polyether polyol with an OH value of 391 were used as hardener (D).

Reactive Adhesive (5):

1-component reactive adhesive based on PU prepolymer (5)

80.75 g PU prepolymer (5) were stirred with 14.25 g tripropylene glycol diacrylate (compound (B)) and 5 g Irgacure 184 (photoinitiator (C)) in the absence of moisture at 70° C. until a homogeneous mixture was obtained. Brookfield viscosity at 70° C.: 4,500 mPa.s.

Reactive Adhesive (6):

2-component reactive adhesive based on PU prepolymer (5)

77.69 g PU prepolymer (5) were stirred with 13.71 g tripropylene glycol diacrylate (compound (B)) and 4.81 g Irgacure 184 (photoinitiator (C)) in the absence of moisture at 70° C. until a homogeneous mixture was obtained. Brookfield viscosity at 70° C.: 4,500 mPa.s.

3.79 g of a polyether polyol with a viscosity of 4380 m.Pas (20° C.), an OH value of 391 and a silicon content of 4.9% by weight were used as hardener (D).

### III. Measuring Methods

Determination of the monomeric polyisocyanate in the polyurethane prepolymer (A) and in the reactive adhesives according to the invention was carried out by gel permeation chromatography (GPC) or high-performance liquid chromatography (HPLC) using an in-house method.

The viscosimetric data were determined with a Brookfield RVT DV-II Digital Viscosimeter, spindle 27.

### IV. Laminating Tests

The laminating tests were carried out on a Polytype laminating machine. Irradiation was carried out with an Eltosch UV unit equipped with a 120 W mercury lamp (UV dose=180 mJ/cm²).

The reactive adhesive was applied in a weight of 2 g/m².

The following materials were laminated:

24 micrometer thick film of oriented polypropylene (OPP film)

19 micrometer thick film of coextruded OPP (coexOPP film)

12 micrometer thick polyester film (PE film)

17 micrometer thick polyethylene film (PE film)

15 micrometer thick film of oriented polyamide (PA film)

The procedure was always lamination first, then irradiation.

### V. Laminate Adhesion and Sealing Seam Adhesion

Laminate adhesion and sealing seam adhesion were measured on 15 mm wide strips using a Zwick Z2.5 tensile testing machine (test speed: 100 mm/min.)

Abbreviations: LA stands for laminate adhesion, SSA stands for sealing seam adhesion.

The results are expressed in N/15 mm.

| Reactive | | | | | |
|---|---|---|---|---|---|
| adhesive = | After 2 h | After 1 d | | After 2 d | |
| RA | LA | LA | SSA | LA | SSA |

Laminate: OPP/coexOPP

| | | | | | |
|---|---|---|---|---|---|
| RA (3) | 2.3; OPP | 2.0; OPP | 6.2; coex | 2.6; OPP | 6.6; coex |
| | failure | failure | failure | failure | failure |
| RA (4) | 1.6; OPP | 2.4; OPP | 5.7; coex | 3.1; OPP | 5.8; coex |
| | failure | failure | failure | failure | failure |

Laminate: PET/PE

| | | | | | |
|---|---|---|---|---|---|
| RA (2) | 3.0; PET | 4.3; PET | 56.2; | 2.2; PET | 59.3; |
| | failure | failure | laminate | failure | laminate |
| | | | failure at | | failure at |
| | | | sealing | | sealing |
| | | | edge | | seam |
| RA (4) | 1.8; | 2.1; | 51.5; | 3.0; PET | 54.6; |
| | adhesive | adhesive | laminate | failure | laminate |
| | alternating | separation; | failure at | | failure at |
| | laminate | adhesive | sealing | | sealing |
| | separation | on PET | edge | | edge |
| RA (5) | 1.7; | 2.0; | 30.1; PET | 2.8; PET | 34.0; one- |
| | adhesive | adhesive | failure at | failure | sided |
| | alternating | alternating | sealing | | laminate |
| | laminate | laminate | edge | | separation |
| | separation | separation | | | via sealing |
| | | | | | seam |

Laminate: OPA/PE

| | | | | | |
|---|---|---|---|---|---|
| RA (1) | 2.1; | 7.3; OPA | 72.8; | 5.3; OPA | 77.4; |
| | adhesive | failure | laminate | failure | laminate |
| | separation; | | failure | | failure at |
| | adhesive | | before | | sealing |
| | on PE | | sealing | | edge |
| | | | edge | | |
| RA (4) | 1.7; | 1.7; | 67.6; PE | 1.9; | 68.8; PE |
| | adhesive | laminate | failure at | laminate | failure at |
| | separation: | separation; | the | separation: | sealing |
| | adhesive | adhesive | sealing | adhesive | edge |
| | on OPA | on PE | edge | on PE | |
| RA (6) | 1.5; | 1.8; | 40.1; PE | 2.1; | 50.2; PE |
| | adhesive | laminate | failure at | laminate | failure at |
| | separation: | separation: | sealing | separation: | sealing |
| | adhesive | adhesive | edge | adhesive | edge |
| | on OPA | on PE | | on PE | |

| | After 7 d | |
|---|---|---|
| Formulation | LA | SSA |

Laminate: OPP/coexOPP

| | | |
|---|---|---|
| RA (3) | 2.4; OPP failure | 6.7; coex failure |
| RA (4) | 3.0; OPP failure | 6.5; coex failure |

Laminate: PET/PE

| | | |
|---|---|---|
| RA (2) | 1.9; PET failure | 48.2; laminate failure at sealing |
| | | edge |
| RA (4) | 3.7; PET failure | 59.8; laminate failure before |
| | | sealing seam |
| RA (5) | 3.5; PET failure | 62.2; laminate failure at sealing |
| | | edge |

Laminate: OPA/PE

| | | |
|---|---|---|
| RA (1) | 4.6; OPA failure | 72.9; laminate failure before |
| | | sealing seam |
| RA (4) | 2.2; laminate separation: | 76.3; laminate failure before |
| | adhesive on PE | sealing seam |
| RA (6) | 2.4; laminate separation: | 71.5; PE failure at sealing edge |
| | adhesive on PE | |

### VI. Migration Test

Reactive Adhesives:

MDI-based:

Low-monomer adhesive (M1):

Low-monomer dual-cure prepolymer (1) 98%+Irgacure 184 2%

Standard-monomer adhesive (M2):

Standard dual-cure prepolymer (2) 98%+Irgacure 184 2%

HDI-based:

Low-monomer adhesive (H1):

Basis {low-monomer dual-cure prepolymer (3) 98%+Irgacure 184 2%} 88.2%

Hardener (polyol mixture, OH value: 390, Brookfield viscosity: 4,400 mPa.s) 11.8%

Standard-monomer adhesive (H2):

Basis {low-monomer dual-cure prepolymer (4) 98%+Irgacure 184 2%} 88.2%

Hardener (polyol mixture, OH value: 390, Brookfield viscosity: 4,400 mPa.s) 11.8%

Extraction Conditions:

All laminates were extracted in the form of bags using 3% acetic acid (100 ml per 400 cm² laminate area) in accordance with BGVV Recommendation XXVIII.

Determination of aromatic amines (MDA: diphenylmethane diamine): under BGVV Recommendation XXVIII, the laminate is migrate-free when the value determined is below 0.2 μg/100 ml.

Determination of aliphatic amines (HDA: 1,6-diaminohexane): after derivatization, the samples were analyzed by liquid chromatography for the degradation product of HDI (1,6-diaminohexane).

| | | | |
|---|---|---|---|
| System | After 1 day | After 2 days | After 3 days |

PET/PE

| | | | |
|---|---|---|---|
| H1 | HDA: <0.02 μg/ml | HDA: <0.02 μg/ml | HDA: 0.02 μg/ml |
| H2 | HDA: 1.5 μg/ml | HDA: 0.635 μg/ml | HDA: 0.47 μg/ml |
| M1 | MDA: <0.2 μg/ | MDA: <0.2 μg/ | MDA: <0.2 μg/ |
| | 100 ml | 100 ml | 100 ml |
| M2 | MDA: 19.77 μg/ | MDA: 10.02 μg/ | MDA: 6.49 μg/ |
| | 100 ml | 100 ml | 100 ml |

OPA/PE

| | | | |
|---|---|---|---|
| H1 | HDA: 0.065 μg/ml | HDA: <0.02 μg/ml | HDA: <0.02 μg/ml |
| H2 | HDA: 1.1 μg/ml | HDA: 0.515 μg/ml | HDA: 0.2 μg/ml |
| M1 | MDA: 0.2 μg/ | MDA: <0.2 μg/ | MDA: <0.2 μg/ |
| | 100 ml | 100 ml | 100 ml |
| M2 | MDA: 46.81 μg/ | MDA: 20.26 μg/ | MDA: 13.10 μg/ |
| | 100 ml | 100 ml | 100 ml |

| After 4 days | After 7 days | After 14 days |
|---|---|---|
| HDA: 0.009 μg/ml | HDA: <0.005 μg/ml | HDA: <0.005 μg/ml |
| HDA: 0.27 μg/ml | HDA: 0.055 μg/ml | HDA: <0.005 μg/ml |
| MDA: <0.2 μg/100 ml | MDA: <0.2 μg/100 ml | MDA: <0.2 μg/100 ml |
| MDA: 1.85 μg/100 ml | MDA: 1.10 μg/100 ml | MDA: <0.02 μg/100 ml |
| HDA: 0.007 μg/ml | HDA: 0.006 μg/ml | HDA: <0.005 μg/ml |
| HDA: 0.17 μg/ml | HDA: 0.016 μg/ml | HDA: <0.005 μg/ml |
| MDA: <0.2 μg/100 ml | MDA: <0.2 μg/100 ml | MDA: <0.2 μg/100 ml |
| MDA: 2.96 μg/100 ml | MDA: 1.63 μg/100 ml | MDA: <0.2 μg/100 ml |

As can be seen from the above Tables, the reactive adhesive systems according to the invention are migration-free after only one day.

1. Solventless or solvent-containing low-monomer reactive adhesive curing in several stages which contains at least one polyurethane prepolymer (A) with a low content of monomeric polyisocyanate (a) and at least one free functional group capable of reacting with a compound containing at least one acidic hydrogen atom, more particularly at least one isocyanate group, and at least one compound (B) containing a functional group polymerizable by irradiation.

2. Solventless or solvent-containing low-monomer reactive adhesive curing in several stages as claimed in claim 1, characterized in that the polyurethane prepolymer (A) is obtainable by reaction of
a) at least one monomeric polyisocyanate (a),
b) at least one polyol (b),
c) optionally at least one compound (c) containing both functional groups polymerizable by irradiation and at least one acidic hydrogen atom and
d) optionally at least one organosilicon compound (d).

3. Solventless or solvent-containing low-monomer reactive adhesive curing in several stages as claimed in claim 1 or 2, characterized in that it contains less than 0.1% by weight monomeric polyisocyanate.

4. Solventless or solvent-containing low-monomer reactive adhesive curing in several stages as claimed in at least one of claims 1 to 3, characterized in that the polyurethane prepolymer (A) contains less than 0.5% by weight monomeric polyisocyanate.

5. Solventless or solvent-containing low-monomer reactive adhesive curing in several stages as claimed in at least one of claims 1 to 3, characterized in that IPDI, HDI, MDI and/or TDI is/are used individually or in admixture as the monomeric polyisocyanate (a).

6. Solventless or solvent-containing low-monomer reactive adhesive curing in several stages as claimed in claim 2, characterized in that the polyol (b) is a polyether polyol and/or polyester polyol with a molecular weight of 200 to 4,000 g/mol or a mixture of polyether polyols and/or polyester polyols which satisfy the limiting criterion of molecular weight.

7. Solventless or solvent-containing low-monomer reactive adhesive curing in several stages as claimed in claim 2, characterized in that compound (c) is at least one compound (c) with a molecular weight of 100 to 15,000 g/mol which contains both at least one functional group polymerizable by exposure to UV light or electron beams and at least one acidic hydrogen atom.

8. Solventless or solvent-containing low-monomer reactive adhesive curing in several stages as claimed in claim 7, characterized in that compound (c) contains a group with an olefinically unsaturated double bond as the functional group polymerizable by exposure to UV light or to electron beams.

9. Solventless or solvent-containing low-monomer reactive adhesive curing in several stages as claimed in claim 2, characterized in that the organosilicon compound (d) is at least one alkoxysilane corresponding to general formula (I):
X-A-Si(Z)ₙ(OR)₃₋ₙ (I)
where X is a residue with at least one reactive functional group containing acidic hydrogen, for example a residue containing at least one OH—, SH—, NH— or COOH— group or a mixture of two or more such groups. A stands for CH₂ or a linear or branched, saturated or unsaturated alkylene group containing 2 to about 12 carbon atoms or for an arylene group containing about 6 to about 18 carbon atoms or for an arylene-alkylene group containing about 7 to about 19 carbon atoms or an alkyl-, cycloalkyl- or aryl-substituted siloxane group containing about 1 to about 20 Si atoms, Z stands for CH₃, O—CH₃ or for a linear or branched, saturated or unsaturated alkyl group or alkoxy group containing 2 to about 12 carbon atoms, R stands for CH₃ or a linear or branched, saturated or unsaturated alkyl group containing 2 to about 12 carbon atoms and n has a value of 0, 1 or 2.

10. Solventless or solvent-containing low-monomer reactive adhesive curing in several stages as claimed in claim 1, characterized in that compound (B) contains at least one functional group polymerizable by exposure to UV light or electron beams.

11. Solventless or solvent-containing low-monomer reactive adhesive curing in several stages as claimed in claim 10, characterized in that compound (B) contains at least one group with an olefinically unsaturated double bond as the functional group polymerizable by exposure to UV light or to electron beams.

12. Solventless or solvent-containing low-monomer reactive adhesive curing in several stages as claimed in any of claims 1 to 11, characterized in that it contains
I) 10 to 98% by weight of at least one polyurethane prepolymer (A),
II) 0.5 to 80% by weight of at least one compound (B),
III) 0 to 15% by weight of at least one photoinitiator (C),
IV) 0 to 60% by weight of at least one hardener (D),
V) 0 to 50% by weight of additives (E),
the sum total of the constituents coming to 100% by weight.

13. Solventless or solvent-containing low-monomer reactive adhesive curing in several stages as claimed in claim 12, characterized in that (C) is a photoinitiator which is capable of initiating the polymerization of olefinically unsaturated double bonds on exposure to UV light.

14. Solventless or solvent-containing low-monomer reactive adhesive curing in several stages as claimed in claim 12, characterized in that the hardener (D) contains at least one compound with at least two functional groups each having at least one acidic hydrogen atom.

15. Solventless or solvent-containing low-monomer reactive adhesive curing in several stages as claimed in claim 14, characterized in that the hardener (D) is at least one polyol bearing at least two OH groups.

16. Solventless or solvent-containing low-monomer reactive adhesive curing in several stages as claimed in claim 12, characterized in that the additives (E) include plasticizers, stabilizers, antioxidants, dyes or fillers.

17. Solventless or solvent-containing low-monomer reactive adhesive curing in several stages as claimed in at least one of claims 1 to 16, characterized in that it has a viscosity of 100 mPas to 26,000 mPas at 70° C., as measured with a Brookfield RVT DV-II Digital Viscosimeter, spindle 27.

18. A process for the production of multilayer materials, characterized in that the solventless or solvent-containing low-monomer reactive adhesive curing in several stages claimed in at least one of claims 1 to 17 is used.
